(19) United States
(12) Patent Application Publication
(10) Pub. No.: US 2008/0205440 A1
(43) Pub. Date: Aug. 28, 2008

(54) Method and Device for Controlling the Switching of at Least One Network-Enabled Device, Particularly Home Appliance, From a First Network Access Device to a Second Network Access Device

(75) Inventor: Johannes Gaugler, Regensburg (DE)

Correspondence Address: LERNER GREENBERG STEMER LLP, P O BOX 2480, HOLLYWOOD, FL, 33022-2480, US

(73) Assignee: BSH BOSCH UND SIEMENS HAUSGERÄTE GMBH, Münich (DE)

(21) Appl. No.: 11/815,462

(22) PCT Filed: Dec. 2, 2005
(86) PCT No.: PCT/EP05/56439

§ 371 Date: Aug. 17, 2007

(30) Foreign Application Priority Data
Feb. 3, 2005 (DE) 10 2005 005 038.7

(51) Int. Cl. H04J 3/22

(52) U.S. Cl. 370/466

(57) ABSTRACT

At least one network-enabled device, particularly a domestic appliance, is switched from a first network access device, that is connected to a communication network device, to a second network access device, that is to be connected to the communication network device, without manual intervention on the device which sends a message thereto after connection to the first network access device and which has received therefrom a clear address that has been allocated in the communication network device. An individual command signal is emitted by a control device that is connected to the communication network device, placing the respective devices that have sent messages to the first network access device in a state resulting in a new message, whereupon a new message occurs in the second network access device when the first network access device is taken away from the communication network device or disconnected by the respective device, enabling the respective device to receive an allocated clear address in the above mentioned communication network device.

The present invention relates to a method and a device for controlling the switching of at least one network-enabled device, especially of a network-enabled home appliance, from a first network access device to a second network access device in a communications arrangement, in which the respective device, after its connection to the first network access device, has registered itself from its initial state at this first network access device and has received from the latter a unique address allocated to it in the said communication network arrangement.

A method and a circuit arrangement are already known for registration of domestic appliances in a communications network formed by a power supply network (DE 691 05 375 T2). With this known method and the circuit arrangement provided for its execution a bistable circuit element is used in each of the domestic appliances connected to the power supply network to provide network access for the respective domestic appliance. To this end the respective bistable circuit element requests in its ON position the allocation of an address by a control device likewise provided in the communication network, and in its OFF position the respective bistable circuit element deactivates this address request function again. Such an address allocation is undertaken for the respective home appliance after its installation in said power supply network. After such an address allocation by the control device mentioned, which to an extent assumes the function of a network access device in doing so, the address allocated to a particular home appliance is known to it. This means however that when a switch is made from said control device as a first control device to a second control device, a re-installation of the respective home appliance is necessary, since in the second control device it is not actually known which address has been allocated to which of the respective home appliances. Therefore the bistable circuit element in the home appliances must be switched again from its OFF position into its respective ON position. This represents a very time-consuming procedure however. Account must be taken of the fact that the relevant bistable circuit elements within the home appliances are frequently located in places which can only be accessed with difficulty and as a rule are only to be accessible to service personnel.

It is however also generally known that programmable electronic devices having an internal reset switch, through actuation of which they can be put into a defined initial state, can alternatively be set by software means into their initial or reset state by supplying them with a corresponding reset command (see for example the Internet literature references:

http://www.chippc.com/support/kbase/answer.asp?1D=CKB00004
http://www.zyxel.com/support/knowledgebasel.php?indexFlagvalue=1021703148&level=3&upFlag=1021681491
http://support.intel.com/design/archive/periphrl/docs/7207. htm).

These reset commands are however only employed to reset the respective electronic device into a defined state from which it can operate normally once again after it has previously operated incorrectly or not at all for example.

The underlying object of the invention is now, with a method and a circuit arrangement of the type mentioned at the start, to undertake the switching of the registration of at least one network-enabled device, especially home appliance, from a first network access device connected to a communication network arrangement to a second network access device to be connected to or already connected to the relevant communication network arrangement in a simple manner without manual interventions in the respective terminals or home appliances.

The present object indicated is achieved by the invention for a method of the type mentioned at the start by, in the course of said switching from a control device connected to the communication network arrangement, a separate reset command signal being issued to the relevant devices registered at the respective first network access device to reset them to a state for new registration and subsequently, for a first network access device removed from the communication network arrangement or switched off, by a new registration being undertaken by the respective device in the second network access device, by means of which the respective device is allocated a unique address in the said communication network arrangement.

The invention brings with it the advantage that, by utilizing the characteristics of the respective device or home appliance, namely those of self-registration from their initial state at a network access device, the stated switching from the first network access device to the second network access device can be achieved solely with the aid of a separate command signal which can be issued by a control device connected to the communication network arrangement. This means that no manual intervention into the individual devices or home appliances is required for said switching.

Preferably, according to a useful development of the inventive method, for a communication network arrangement with at least two communication networks, to the one communication network of which the respective devices are connected via network access devices and of which further communication networks are each connected by means of gateway devices to the said one communication network or to each other, the separate command signal is issued by one or via one of the gateway devices. This produces the advantage of an especially small control effort for issuing the separate command signal.

A device of the type stated at the start is preferably used for executing the method in accordance with the invention, which is characterized in that a control device is connected to the communication network arrangement, which in the course of said switching allows a separate command signal to be issued to put the relevant devices registered at the relevant first network access device into a state which causes them to perform a new registration, after the issuing of which, with a first network access device removed from the communication network arrangement or switched off, a new registration procedure is only able to be executed with the said second network access device.

This produces the advantage of a particularly low outlay as regards circuitry and devices for the control of a switching of registration of at least one network-enabled device, especially home appliance, from a first network access device connected to a communication network arrangement to a second network access device to be connected to or already connected to the respective communication network arrangement. In is namely possible to make do with only one command signal generator to be provided or already provided in a control device connected to the communication network arrangement, which allows a separate command signal to be issued to put the device involved into a state which brings about a new registration. Further circuit or device interventions are not required to undertake the switching of the registration of at least of one network-enabled device, especially of a home appliance, from the first network access device to the second network access device.

A useful further development of the inventive device consists of the control device being embodied by a gateway device which links the communication networks forming the communication network arrangement, or by a control and/or monitoring device connected or able to be connected to this gateway device. This produces the advantage of being able to manage without any additional devices.

An exemplary embodiment of the present invention is explained below in greater detail with reference to a drawing. The drawing is a schematic diagram of a communication network arrangement comprising a plurality of communication networks, to which a plurality of terminals, which in particular involve home appliances, are connected via network access or gateway devices.

The schematic diagram depicts a plurality of home appliances HG1 . . . HGn which are connected via bus coupler units or bus couplers BCU1 . . . BCUn via network access units to a bus arrangement HB which forms a first communication network of the stated communication network arrangement. In the present case each of the home appliances HG1 . . . HGn is connected via a separate bus coupler of the bus couplers BCU1 . . . BCUn associated with it to the bus line arrangement HB. It should be noted here that where necessary a number of home appliances can also be connected to one bus coupler. The bus line arrangement HB forming a first communication network is connected by gateway devices GW1 to GWx, also simply called gateways, to further communication networks NET1 to NETx of the relevant communication network arrangement, to which external control and/or monitoring devices PC1 to PCx are connected. It should be noted at this point that a very similar arrangement of home appliances has already been described in greater detail elsewhere (see DE 103 13 360 A1).

The home appliances HG1 . . . HGn depicted in the drawing are for example similar or different home appliances belonging to one household or to different households, such as one or more washing machines, one or more electric cookers, one or more dishwashers, one or more microwave devices, one or more refrigerators, one or more extractor hoods, one or more air conditioning units, one or more coffee machines, one or more vacuum cleaners, one or more hobs or one or more freezers etc. for example. The home appliances HG1 . . . HGn involved are not shown in detail here; instead only those elements necessary for the understanding of the present invention are shown, and in more precise terms only in relation to the home appliance HG1.

The elements of the home appliance HG1 mentioned above include a central processing unit CPU which is connected to an internal bus IB to which a read-only memory ROM and a random access memory RAM are connected as well as, via a parallel or serial home appliance-internal interface device IFA, a display device D and controls B are connected. Operating programs used for the operation of the home appliance HG1, which can be executed with the aid of central processing unit CPU, are stored in the read-only memory ROM. The random access memory RAM serves during the execution of these types of operating program as working memory of the memory system shown. The central processing unit CPU can also be employed here together with the memory ROM and RAM for execution of various further tasks, such as for execution of an appropriate state for resetting the home appliance HG1, in which a new registration procedure is performed by issuing an appropriate registration signal, and this is done in response to a separate command signal which is supplied to the relevant home appliance HG1.

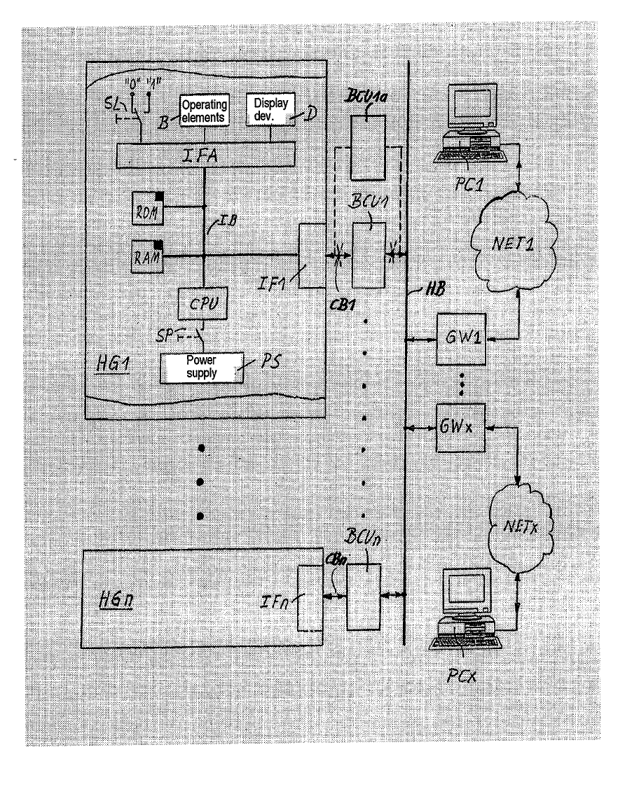

The central processing unit CPU is connected via a switch shown in FIG. 1 to a power supply device PS which can either be the power supply of the home appliance HG1, such as the AC power supply device of this home appliance for example, or can also be an own or separate power supply device of this home appliance HG1. In the last case mentioned this power supply PS remains available for example even if the supply or AC mains voltage used to operate the home appliance HG1 involved fails, to enable the home appliance-internal computer system (CPU, ROM, RAM) shown to be provided with specific state or notification signals for a possible remote interrogation.

In this instance a further interface device IF1, which represents a bus arrangement consisting of a number of lines, is connected to the internal bus IB of the home appliance HG1 which is used for communication connections to and from the relevant home appliance HG1. This interface device IF1 can for example be a serial interface device or a parallel interface device as normally used for data transmission. The previously mentioned remote interrogation can be undertaken via this interface device IF1 for example.

A mechanical registration switch SL which is usually positioned at a location in the home appliance HG1 which is not easy to access (normally only accessible for service personnel) is also connected to the above-mentioned interface device IFA of the home appliance HG1. The mechanical registration switch SL can be set to at least two different positions; in the present instance it is also only able to be set to these two different switch positions. In one switch position what could be referred to as the bistable mechanical registration switch SL, which can for example be provided by a toggle switch, issues a signal corresponding to a logical signal or bit “0” to the interface device IFA. In its other switch position the relevant mechanical registration switch SL issues a signal corresponding to a logical signal or bit “1” to the registration switch IFA. Basically the relevant mechanical registration switch SL can also issue to the interface device IFA different address signals as signals which differ from one another in accordance with its respective setting. Of the different signals mentioned, only either the one signal (e.g. the signal corresponding to a logical signal or bit “1”) or a signal switch, i.e. a switch from a signal to another signal as registration or initialization signal are used, which the relevant home appliance HG1 issues to notify itself to the communication network including the bus line arrangement HB and is thereby registered in this; where necessary this registration is combined with a basic setting in the relevant home appliance of different states, especially an address transfer—i.e. an initialization.

The previously considered mechanical registration switch SL is only able to be set here into two stable switch settings. It is however also possible to provide a mechanical registration switch able to be set to three different stable switch positions for example. Such a registration switch could for example in its first switch setting issue no signal at all to the interface device IFA or issue a signal blocking the putting into service of the home appliance and in its second and third switch positions for example issue a signal corresponding to a binary signal “0” or a signal corresponding to a binary signal “1”.

It should be pointed out in relation to the home appliance HGn shown schematically in the diagram that this can be constructed with the same circuit arrangement as the previously considered home appliance HG1. The home appliance HGn depicted is equipped with a separate interface device IFn corresponding to the previously mentioned interface device IF1. This interface device IFn can likewise be a parallel or serial interface device.

With their interface devices IF1 and IFn the home appliances HG1 to HGn are connected in the drawing via connecting lines, shown as bidirectionally operating access lines CB1 to CBn, to associated bus couplers BCU1 to BCUn. The home appliances HG1 to HGn are connected via these bus couplers BCU1 to BCUn which represent network access devices, to the first communication network, which is shown in FIG. 1 by a wired communication network comprising a single bus line arrangement HB, which can have a large number of individual lines available to it. One purpose of the bus couplers BCU1 to BCUn mentioned here is to convert home appliance-specific protocols or data formats (meaning so-called proprietary protocols) into bus-uniform or standardized protocols or data formats, and conversely they are used to convert the bus-uniform or standardized protocols or data formats in the bus line arrangement HB into home appliance-specific protocols or data formats for the individual home appliances. This means that here it is not the home appliances HG1 to HGn alone which are responsible for the data exchange and the bus-typical network management above all the bus couplers BCU1 to BCUn.

The bus line arrangement HB forming the first communication network or belonging to this network can, in the event of the home appliances HG1 . . . HGn being located in one house or in adjacent houses, be what is known as a home bus which forms the first communication network for all the home appliances in the relevant house or in the relevant houses.

It should be noted at this point that the first communication network with the bus line arrangement HB can also be a wired communication network of which the communication lines are formed by the power supply lines of the individual home appliances fed from an AC mains source. This means that in these cases the communications between the bus couplers BCU1 . . . BCUn and the gateway units GW1 . . . GWx run over power supply lines of the individual home appliances which are connected to the relevant bus couplers BCU1 . . . BCUn.

In addition the first communication network comprising the bus line arrangement HB can also be operated as a wireless network, in which the individual home appliances communicate by means of transmit-receive devices, which then fulfill the functions of said bus couplers BCU1 . . . BCUn.

Said gateway devices or gateways GW1 to GWx are connected to the bus line arrangement HB forming the first communication network in the present exemplary embodiment, and the relevant first communication network is connected to at least a second communication network of the communication arrangement comprising at least two communication networks via these gateways; in the present case there is a plurality of further communication networks NET1 to NETx. These further communication networks NET1 to NETx can for example involve a public communication network or the Internet. Connected to the relevant further communication networks NET1 to NETx are, as shown in the drawing, external control and/or monitoring devices, which can be formed for example by personal computers PC1 to PCx.

The drawing shows a further bus coupler BCU1a in addition to the bus couplers BCU1 . . . BCUn which is connected in parallel to the bus coupler BCU1 via a connecting line shown as a dashed line. This further bus coupler BCU1a is intended, as is explained below, to act as a second bus coupler in the place of the first bus coupler BCU1, this being illustrated in the drawing by the fact that the connecting lines of the bus coupler BCU1 to the interface device IF1 of the home appliance HG1 and to the home bus forming the first communication network HB are marked by lines crossed through with an uppercase X. This is intended to show that the first bus coupler BCU1 is to be replaced by the further or second bus coupler BCU1a. This replacement can be by a device-for-device replacement of the first bus coupler BCU1 by the further or second bus coupler BCU1a, or also by the first bus coupler BCU1 being deactivated, i.e. rendered ineffective by a further bus coupler BCU1a connected in parallel to it.

Now that the layout of the device or arrangement shown in the drawing have been explained to an extent necessary to enable the present invention to be understood, a few procedural sequences will be briefly explained in conjunction with the home appliance HG1 before and after the replacement of the bus coupler BCU1 by the further bus coupler BCU1a.

First of all the case is considered in which the bus coupler BCU1 is present and is not to be replaced by the further bus coupler BCU1a.

If for example home appliance HG1 shown in the drawing is connected to the bus line arrangement HB via its associated bus coupler BCU1 and registers itself with the latter for example by an actuation of the associated registration switch SL and issues a communication signal linked to this, a notification and thereby a registration procedure then runs by means of the bus coupler BCU1 for the relevant home appliance HG1 in the first communication network including the bus line arrangement HB. The relevant registration procedure begins for example with a so-called house address management, followed for example by a chaining or link address management.

The house address management, as detailed here for example, corresponds to an address search method referred to as trial and error. In this case the home appliance HG1 is given a unique house address within the first communication network among the home appliances HG1 . . . HGn connected to the bus line arrangement or home or house bus HB. To this end a house address search is undertaken from the associated bus coupler BCU1 of the relevant home appliance HG1 outwards; this bus coupler BCU1 generates addresses and issues these via the home or house bus HB. If such an address is already issued for another home appliance, such as home appliance HGn for example, its associated bus coupler, such as bus coupler BCUn, indicates this to a certain extent as a “claim”. The bus coupler BCU1 of the first home appliance HG1 then attempts it with at least one other address, until finally a “positive” response is available from the other bus couplers which are connected to the home bus HB. This address is then allocated as a house address to home appliance HG1 within the home appliance network concerned in the virtual network considered, and it also remains allocated to the relevant home appliance HG1 in this network in the associated bus coupler BCU1, e.g. after the relevant home appliance HG1 is switched off or after it has been removed from and reconnected to the associated bus coupler BCU1. A requirement is here that even after the relevant home appliance HG1 is switched off or after its removal from and reconnection to the associated bus coupler BCU1, this bus coupler BCU1 is still present.

The relevant home appliance, such as the home appliance HG1, is in fact provided with a unique house address by the house address management explained above; but the relevant home appliance HG1 is however not yet accessible here in this way from the other communication networks NET1 and NETx via the bus line arrangement, meaning the home or house bus HB. To ensure this accessibility, information is namely still needed about the bus coupler via which the relevant home appliance is connected to said bus line arrangement HB. This is now followed by application of a chaining or link address management, through which the bus coupler of a home appliance in relation to which a house address management has just been carried out, receives a unique link address within the virtual network containing the bus line arrangement or the house bus HB.

In principle a method is executed in this procedure corresponding to that previously explained for house address management. Initially one or more link address attempts are executed and only after a “positive” response from the other bus couplers does the bus coupler which has just executed the chain or link address management have an address that it can use. The address thus determined is finally stored in the relevant bus coupler, such as the bus coupler BCU1 of the home appliance HG1, which thus has the whole address available under which the relevant home appliance, such as the home appliance HG1, is uniquely identified or addressable in the virtual network including the bus line arrangement or the house bus HB.

The case is now considered in which a switch of at least one home appliance, such as the home appliance HG1 for example, from bus coupler BCU1 as a first network access device to further bus coupler BCU1a as a second network access device is undertaken in a controlled manner, without the registration switches, such as the registration switch SL, in the home appliances registered at the bus coupler BCU1, such as in the home appliance HG1, having to be activated.

The previously mentioned control is undertaken here for example by one of the gateways GW1 to GWx which operates or operate as a control device. To this end the relevant gateway, such as the gateway GW1 acting as control device, issues to the home appliance registered at the bus coupler BCU1, i.e. in the present case to the home appliance HG1 registered there, a control command controlling the device or devices so as to place it or them into a state which brings about a new registration. To this end the relevant command signal, after its arrival in the home appliance HG1 for example, is evaluated by this associated computer system (CPU, ROM, RAM) for initiation of the new registration procedure. The relevant command signal can if necessary also be used for switching off the said first bus coupler BCU1. In the home appliance HG1 said separate command signal causes home appliance HG1 to be controlled so that it assumes a state which brings about a new registration. The initial or new registration state corresponds to the state which, by activation of the associated registration switch SL of the relevant home appliance HG1, leads to this home appliance HG1 registering itself—once again—at the communication network arrangement with the communication networks HB, NET1 and NETx. This registration is however now undertaken via the further bus coupler BCU1a, which is switched on the input and output side in parallel to the ineffective bus coupler BCU1 or which is connected in its place. The same processes now run in the further bus coupler as have been described above in relation to the bus coupler BCU1 after the registration of the home appliance HG1. This means that initially a house address management is performed and that subsequently a chaining or link address management is executed.

The issuing of the separate command signal to the home appliance HG1 thus does not just effect a simple control of the home appliance HG1 in its initial state—in which no further actions are undertaken from home appliance HG1—but rather it effectively corresponds much more to a new activation of the registration switch SL of the relevant home appliance HG1. Only in this way is the new registration procedure initiated from the home appliance HG1.

The transmission of said separate command signal to the home appliance HG1 is then followed at the bus coupler BCU1 removed from the communication network arrangement or switched off by a new registration by the home appliance HG1 in the further bus coupler BCU1 already linked to the communication network arrangement.

It has been explained here that the separate command signal is issued for example by the gateway GW1 serving as the control device. The relevant command signal can however also be issued by other control devices. Any other device connected to the communication network arrangement as control device, such as the personal computers PC1 to PCx shown in the drawings can for example serve as a control device. In this case said separate command signal is issued via the relevant gateway device. It has also been explained here that the relevant command signal, after its arrival in the home appliance HG1, is evaluated by the computer system (CPU, ROM, RAM) associated with this device for triggering the new registration procedure by issuing a corresponding notification signal via the associated interface device IF1. It is however also possible for said command signal to already be detected in the interface device IF1 itself and to be evaluated with the issuing of a corresponding notification signal. This means that in this case this interface device IF1 itself triggers said new registration procedure in the bus coupler BCU1. In this case the triggering of said new registration procedure corresponds to the initial state of the home appliance HG1, from which the first network registration was undertaken.

### LIST OF REFERENCE SYMBOLS

B Operating elements BCU1, BCUn bus coupler
BCU1a Further bus coupler
CB1, CBn Connecting, access lines
CPU Central Processing Unit
D Display device
GW1, GWx Gateway
HB Bus line arrangement, home bus, house bus
HG1, HGn Home appliance
IB Internal bus
IF1, IFn Interface device
IFA Interface device NET1, NETx further communication networks
PC1, PCx External control and/or monitoring devices, personal computer
PS Power supply
RAM Random Access Memory
ROM Read Only Memory
SL Registration switch
SP Switch

1-4. (canceled)

5. A method of controlling a switching of a network-enabled device from a first network access device to a second network access device in a communication network configuration, wherein:
the network-enabled device, after connecting to the first network access device, has registered itself from an initial state thereof at the first network access device and has received from the first network access device a unique address in the communication network configuration;
functions of the network access device include converting home appliance-specific protocols or file formats into bus-uniform or standardized protocols or data formats of the bus network and converting bus-uniform or standardized protocols or data formats of the communication network into home appliance-specific protocols or data formats; and
a control device is connected to the communication network configuration;
the method which comprises:
issuing a separate command signal in a course of the switching by the control device, the command signal controlling the respective devices registered at the first network access device to put the respective devices into a state bringing about a new registration through which a new registration procedure is initiated from the respective device;
subsequently, with the first network access device switched off or removed from the communication network configuration, undertaking a new registration of the respective device in the second network access device, and thereby obtaining with the respective device a unique address in the communication network configuration.

6. The method according to claim 5, wherein the network enabled device is a network-enabled home appliance.

7. The method according to claim 5, which comprises, in a communication network configuration with at least two communication networks, issuing the separate command signal from one gateway device or via one of the devices to the one communication network of which the respective devices are connected via a network access device and of which the further communication networks are each connected by way of a gateway device to the said one communication network or to each other.

8. A device for executing the method according to claim 5 for controlling a switch of a network-enabled device from a first network access device to a second network access device in a communication network configuration, wherein:
the network-enabled device, after connecting to the first network access device, has registered itself from an initial state thereof at the first network access device and has received from the first network access device a unique address in the communication network configuration;
functions of the network access device include converting home appliance-specific protocols or file formats into bus-uniform or standardized protocols or data formats of the bus network and converting bus-uniform or standardized protocols or data formats of the communication network into home appliance-specific protocols or data formats; and
a control device connected to the communication network configuration;
said control device issuing a separate command signal in a course of the switch, the command signal controlling the respective devices registered at the first network access device to put the respective devices into a state bringing about a new registration through which a new registration procedure is initiated from the respective device; and
wherein subsequently, with the first network access device switched off or removed from the communication network configuration, a new registration procedure is enabled for execution only with said second network access device.

9. The device according to claim 8, wherein said network enabled device is a network-enabled home appliance.

10. The device according to claim 8, wherein said control device is a gateway device connecting the communication networks of the communication network configuration to each other, or a control and monitoring device connected or connectable to the gateway device.
